(19) United States
(12) Patent Application Publication
(10) Pub. No.: US 2022/0178515 A1
(43) Pub. Date: Jun. 9, 2022

(54) COLOR CORRECTING OPTICAL COMPONENT

(71) Applicant: Ecosense Lighting Inc., Los Angeles, CA (US)

(72) Inventor: Paul Kenneth Pickard, Los Angeles, CA (US)

(21) Appl. No.: 17/541,875

(22) Filed: Dec. 3, 2021

Related U.S. Application Data
(60) Provisional application No. 63/120,989, filed on Dec. 3, 2020.

(51) Int. Cl. F21V 9/30; F21V 17/10

(52) U.S. Cl. CPC F21V 9/30; F21V 17/105

(57) ABSTRACT

A color correcting optical component (CCOC) for reducing the correlated color temperature (CCT) of a light source emitting a first light, the CCOC comprising: (a) a light transmitting component, the light transmitting component being discrete from the light source; (b) a connector operatively attached to the light transmitting component for connecting the light transmitting component to the light source such that at least a portion of the first light passes through the light transmitting component; (c) a plurality of quantum dots (QDs) disposed in the light transmitting component, the QDs configured to downconvert a portion of the first light to a second light, wherein the light transmitting component emits emitted light comprising a combination of at least the first light and second light.

### REFERENCE TO RELATED APPLICATION

This application claims the benefit of U.S. Provisional Application No. 63/120,989, filed Dec. 3, 2020, which is hereby incorporated by reference in its entirety.

### FIELD OF INVENTION

The present application relates, generally, to modifying the color of light emitted from a lamp, and, more specifically, to a color correcting optical component (CCOC) for reducing the correlated color temperature (CCT) of light from a light source.

### BACKGROUND

Conventionally, “color correction” of light from 3000K down to, approximately, 2700K, 2500K, or 2200K is performed by using a ¼, ½ or ¾ color temperature orange (CTO) filter, respectively. The challenge with this approach is that the only way a filter can shift a spectral power distribution (SPD) from a cooler to warmer temperature is to absorb light in the 400-575 nm range. Often this is accomplished with a filter that is fairly broad, thus detrimentally suppressing light in the yellow/green region, where the photopic curve is centered. More specifically, as can be seen from the plots in FIGS. 1-3, where 3000K (blue plot line) is overlayed with 2700K, 2400K, and 2200K (red plot lines) the green “shoulder” between 500-550 nm must be suppressed, as well as the blue peak at around 450 nm, in order to make the 3000K plot conform with the warmer CCTs. But since the proportions between blue, green and red need to be maintained, there is insufficient red on a normalized spectral power basis. As a result, blue, green, and yellow must all be suppressed to make the resultant SPD (3000K post filter) a scaled-down version of the target SPD. Lumens are wasted trying to achieve this outcome.

What is needed is a color correcting optical component (CCOC) for reducing the correlated color temperature (CCT) without reducing lumens by absorbing in the yellow/green region. The present invention fulfills this need, among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Applicant recognizes that using quantum dots (QDs) in an CCT converter will allow for true conversion of shorter wavelength light (e.g., violet or blue) into red, while leaving yellow and green light untouched. The approach has multiple advantages, including: (1) lumens are not wasted by absorbing in the yellow/green region; (2) red output can be tuned to optimize color fidelity; and (3) reducing violet/blue light pushes the color point of the emitted light to the right on the CIE diagram, and adding red light pulls the color point down on the CIE diagram, and thus (1) because red output is closer to the photopic curve than the blue/violet, the added lumen output in red helps lumen efficacy, and (2) because the shift is to the right and down, this will tend keep the color point closer to the black body curve or perhaps shift below it—which is preferential for warmer CCTs.

In one embodiment, the invention relates to a color correcting optical component (CCOC) for reducing the correlated color temperature (CCT) of a light source emitting a first light, the CCOC comprising: (a) a light transmitting component, the light transmitting component being discrete from the light source; (b) a connector operatively attached to the light transmitting component for connecting the light transmitting component to the light source such that at least a portion of the first light passes through the light transmitting component; (c) a plurality of quantum dots (QDs) disposed in the light transmitting component, the QDs configured to downconvert a portion of the first light to a second light, wherein the light transmitting component emits emitted light comprising a combination of at least the first light and second light.

### BRIEF DESCRIPTION OF FIGURES

FIGS. 1-3 shows the effects of a CTO filter on a spectrum for different CCT values.

FIG. 4 shows one embodiment of the CCOC of the present invention.

FIG. 5 shows one embodiment of the CCOC of the present invention in combination with TIR component.

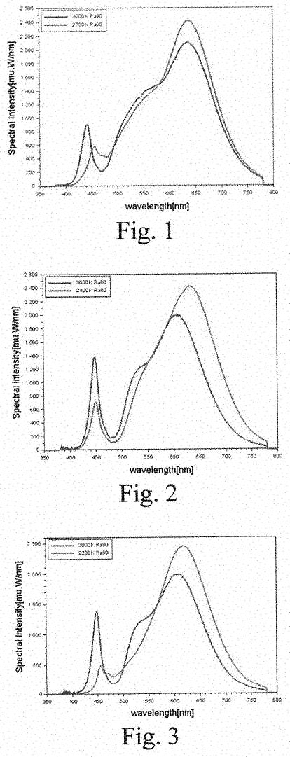

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

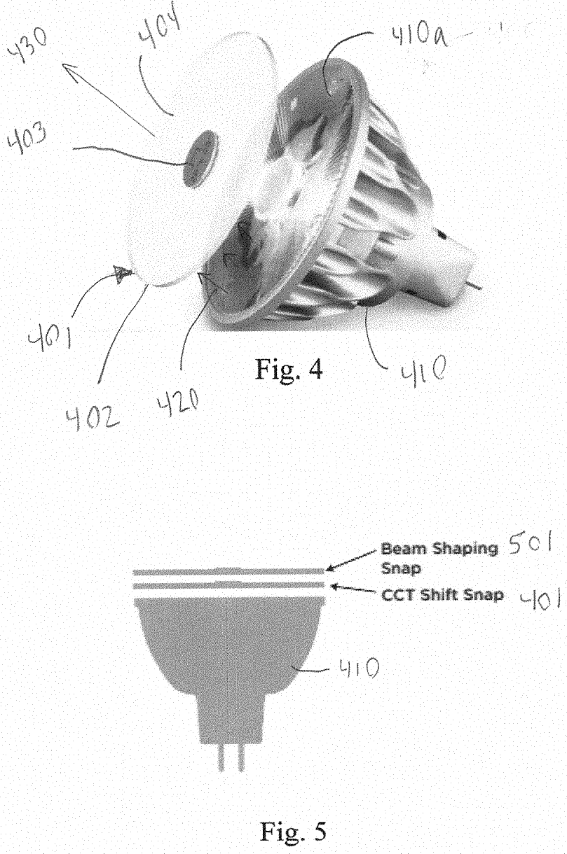

Referring to FIG. 4, one embodiment is shown of the color correcting optical component (CCOC) 401 of the present invention for reducing the correlated color temperature (CCT) of a light source 410 emitting a first light 420. The CCOC 100 comprises a light transmitting component 402, the light transmitting component being discrete from the light source 410 and a connector 403 operatively attached to the light transmitting component 402 for connecting the light transmitting component 402 to the light source 410 such that at least a portion of the first light 420 passes through the light transmitting component. A plurality of quantum dots (QDs) 404 are disposed in the light transmitting component. The QDs 404 are configured to downconvert a portion of the first light 420 to a second light, wherein the light transmitting component emits emitted light 430 comprising a combination of at least the first light and second light. The features of the CCOC 401 are described in greater detail in below and in connection with selected alternative embodiments.

The QDs are configured to downconvert a component of light having a relatively short wavelength to a longer wavelengths. In one embodiment, the QDs are non-cadmium containing QDs. Such QDs are known and commercially available (See, e.g., https://www.nanosysinc.com/products and https://crystalplex.com). In one embodiment, the first light comprises at least a blue or violet component and the QDs downconverts a portion of the blue or violet component to red light. In a more particular embodiment, the first light comprises a blue component and the QDs downconverts a portion of the blue component to red light.

The QDs of the OCCOC function to lower the CCT of the emitted light without substantially reducing luminous flux. In one embodiment, the first light has a CCT of at least 3000K and the emitted light has a reduced CCT of no greater than 2700K, or no greater than 2400K, or no greater than 2220K. In one embodiment, the reduction of CCT does not result in a significant reduction of luminous flux. For example, assuming that the first light has a first luminous flux, in one embodiment, the emitted light has an emitted luminous flux no less than 80% of the first luminous flux, or no less than 85% of the first luminous flux, or no less than 90% of the first luminous flux, or no less than 95% of the a first luminous flux. In one embodiment, the CCOC of the present invention minimizes the reduction of luminous flux by not using a filter.

An advantage of using QDs is their relatively low light scattering compared to other downconverters, such as, for example, phosphors. By way of background, often lamps are configured as spot lamps in which the emitted light has a narrow beam angle, for example, 10-15 degrees. Light scattering of a CCOC used to reduce the CCT will significantly impact beam angle. However, the low light scattering characteristics of QDs reduce the negative effect the CCOC may have on beam angle. More specifically, as addressed in https://www.nature.com/articles/s41598-017-16966-2 hereby incorporated by reference, QDs have about 30% collimating transmittance and 10% scattering with a blue pump. Therefore, for a blue pump beam, the ratio of light staying in the beam to scattering is around 3:1 If the beam is a red pump beam, then the ratio is about 3-4:1 In terms of lumens, this means about 75% of the lumens remain in the beam (in this example), and about 25% of the lumens are scattered outside the beam. Therefore, while there is some beam degradation, it is much less what would be encountered with phosphor, which has essentially no collimating transmittance, and thus would turn the collimated source into a Lambertian distribution on phosphor incidence. In one embodiment, the CCOC is configured such that the light emitted from the CCOC has a beam angle of less than 50 degrees, or less than 40 degrees, or less than 30 degrees, or less than 20 degrees.

The CCOC may be configured in different ways. For example, in one embodiment, the CCOC is configured as a disk as shown in FIG. 4. In such an embodiment, the light transmitting component may comprise a glass or plastic substrate (or other optically transparent material) and the QDs may be suspended in a polymeric matrix applied to the substrate. The concentration of QDs in the matrix can vary according to the degree of downconversion/color shift is desired and thickness of film or coating. For example, a very thin film (e.g., films as thin as about 0.05 mm) may have QD concentration by weight of more than 10%, or more than 15%, or more than 20%, or more than 30%. Generally, although not necessarily, the weight concentration of the QD in very thin films will be less than 50%, or less than 45% or less than 40%. Thicker films (e.g., films from 0.5 to 1.0 mm) will tend to have lower weight concentrations, for example, the QD concentration by weight may be less than 0.5%, or less than 1%, or less than 5%, or less than 10%. One of skill in the art will appreciate that between very thin films and thick films, weight concentrations of QDs will be between the concentrations listed above.

In one embodiment, as shown in FIG. 4, the CCOC is configured as a discrete component. In one embodiment, the discrete component is configured as an Ecosense SNAP component as disclosed in https://www.soraa.com/products/snap_system.php, hereby incorporated by reference. In an alternative embodiment, the CCOC is integrated with the light transmitting component.

In one embodiment, the CCOC further comprises a total internal reflection (TIR) optics to configure the beam angle or shape. In one embodiment, the TIR optics are configured in a discrete component overlaid on the CCOC as disclosed in https://www.soraa.com/products/snap_system.php. For example, referring to FIG. 5, the CCOC 401 of FIG. 4 is overlaid with a beam shaping SNAP component 501. In an alternative embodiment, the CCOC is integrated with TIR optics.

In one embodiment, the CCOC is discrete from the light source and is attached to the light source with a connector 403. In one embodiment, the connector connects the CCOC to the light emitting surface 410a of the light source 410. In one embodiment, the connector releasably connects the CCOC to the light emitting surface. In one embodiment, the connector is a magnetic connector. In one particular embodiment, the CCOC comprises a connection mechanism similar to that used in the commercially available Ecosense SNAP systems, see, for example, https://www.soraa.com/products/snap_system.php, hereby incorporated by reference. It should be obvious to those of skill in the art in light of this disclosure that the magnetic connector on the CCOC may comprise a magnet or a ferrous metal. Alternatively, rather than a magnetic connector, other know connection mechanisms may be used such as snaps, latches, threaded interconnections, friction interconnections, and adhesives.

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A color correcting optical component (CCOC) for reducing the correlated color temperature (CCT) of a light source emitting a first light, said CCOC comprising:
a light transmitting component, said light transmitting component being discrete from said light source;
a connector operatively attached to said light transmitting component for connecting said light transmitting component to said light source such that at least a first portion of said first light passes through said light transmitting component;
a plurality of quantum dots (QDs) disposed in said light transmitting component, said QDs configured to downconvert at least a second portion of said first portion of said first light to a second light, wherein said light transmitting component emits emitted light comprising a combination of at least said second light and a third portion of said first light.

2. The CCOC of claim 1, wherein said first light comprises at least a blue or violet component and said QDs downconverts a portion of said blue or violet component to red light.

3. The CCOC of claim 1, wherein said first light comprises a blue component and said QDs downconverts a portion of said blue component to red light.

4. The CCOC of claim 1, wherein said first light has a CCT of at least 3000K and said emitted light has a CCT of no greater than 2700K, or no greater than 2400K, or no greater than 2220K.

5. The CCOC of claim 1, wherein said first light has a first luminous flux and said emitted light has an emitted luminous flux no less than 80% of said a first luminous flux, or no less than 85% of said first luminous flux, or no less than 90% of said first luminous flux, or no less than 95% of said first luminous flux.

6. The CCOC of claim 1, wherein said CCOC does not filter light.

7. The CCOC of claim 1, wherein said CCOC is configured such that said emitted light diverges at a beam angle of less than 50 degrees, or less than 40 degrees, or less than 30 degrees, or less than 20 degrees.

8. The CCOC of claim 7, further comprising total internal reflection (TIR) optics to configure said beam angle.

9. The CCOC of claim 8, wherein said TIR optics are integrated with said light transmitting component.

10. The CCOC of claim 8, wherein said TIR optics are discrete from said light transmitting component.

11. The CCOC of claim 1, wherein said light source has a light emitting surface, and wherein said connector connects said CCOC to said light emitting surface.

12. The CCOC of claim 11, wherein said connector releasable connects said CCOC to said light emitting surface.

13. The CCOC of claim 12, wherein said connector is a magnetic connector.

14. The CCOC of claim 13, wherein said connector comprises a magnet.

15. The CCOC of claim 13, wherein said connector comprises a ferrous metal.

16. The CCOC of claim 1, wherein said light transmitting component comprises a glass or plastic substrate and said QDs are suspended in a polymeric matrix applied to said substrate.

17. The CCOC of claim 1, wherein the QDs are non-cadmium QDs.
